(19) United States
(12) Patent Application Publication
(10) Pub. No.: US 2009/0045692 A1
(43) Pub. Date: Feb. 19, 2009

(54) Capped stator core wedge and related method

(75) Inventors: Elena Rozier, Schnectady, NY (US); Waheed Tony Mall, Halfmoon, NY (US); Jeffrey D. Sheaffer, Glenville, NY (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 11/889,928

(22) Filed: Aug. 17, 2007

(51) Int. Cl. H02K 3/487; H02K 15/00; H02K 15/02; H02K 3/32

(52) U.S. Cl. 310/214; 29/596; 310/215

(57) ABSTRACT

A slot wedge for a generator stator includes a wedge body having top and bottom surfaces and a pair of oppositely inclined side surfaces, wherein at least the oppositely inclined surfaces are covered with a woven aramid fabric. A related method includes the steps of: (a) providing a wedge shaped body having top and bottom surfaces connected by oppositely inclined side surfaces; and (b) covering at least the oppositely inclined side surfaces with a woven aramid fabric.

The technology disclosed herein relates generally to the repair of rotary machines and, more specifically, to wedges used for the retention of conductor (or stator) bars in the stator core slots of dynamoelectric machines.

### BACKGROUND

Large dynamoelectric machines such as electrical generators employ a laminated stator core for transmitting induced voltages to the generator terminals through stator conductor bars. The cores are usually made by assembling already-slotted punchings or laminations in an annular housing for later containing the generator rotor. The slotted punchings, when assembled, define axially-extending radial slots which terminate at the radially inner-circumference of the stator annulus. The stator bars, or conductors, are laid in the radial slots and a wedging system is used to hold the bars in place against electromagnetic forces present when the machine is operating. If the wedging system is not effective, conductor insulation may be damaged in the ensuing vibration, ultimately leading to a forced outage of the generator.

Electromagnetic fields in the generator induce forces on stators bars during normal operation or short circuit conditions that require wedges to support and hold the bars within the stator slots.

Currently fiberglass laminate material (such as, for example, National Electrical Manufacturers Association (NEMA) G11) is used in making the wedges, and while G11 provides good mechanical strength, it is abrasive to the stator laminations.

Cotton phenolic material has also been used as a wedge material which is non-abrasive to the core but has lower thermal and mechanical capability versus fiberglass laminates such as G11. The reduced mechanical strength and thermal capability of cotton phenolic limits the application of wedges made using this material.

Other solutions such as low friction coatings have not proven completely successful, primarily because they are insufficiently abrasion resistant.

In U.S. Pat. No. 4,200,818, there is disclosed a stator wedge partially covered with a non-woven felt made of Kevlar®, and U.S. Pat. No. 4,607,183 discloses a wedge with an abrasion resistant layer.

There remains a need for wedges exhibiting the properties of fiberglass laminates such as G11 but that have nonabrasive surface for use in dynamoelectric machines.

### BRIEF SUMMARY OF THE INVENTION

In one aspect, the present invention relates to a slot wedge for a generator stator comprising a wedge body having top and bottom surfaces and a pair of oppositely inclined side surfaces, wherein at least said oppositely inclined surfaces are covered with a woven aramid fabric. The woven aramid fabric provides a non-abrasive interface between the fiberglass wedge body and the stator core laminations.

In another aspect, the invention relates to a method of making a slot wedge for a generator stator comprising: (a) providing a wedge shaped body having top and bottom surfaces connected by oppositely inclined side surfaces; and (b) covering at least the oppositely inclined side surfaces with a woven aramid fabric. The woven aramid fabric provides a nonabrasive interface between the fiberglass wedge body and the stator core laminations.

The stator wedge technology disclosed herein will now be described in detail in connection with the below identified drawings.

### BRIEF DESCRIPTION OF THE DRAWINGS

FIG. 1 is a partial perspective view of a lower portion of a generator stator showing conventional dovetail wedges; and

FIG. 2 is a perspective view of a pressure wedge in accordance with this invention.

### DETAILED DESCRIPTION OF THE INVENTION

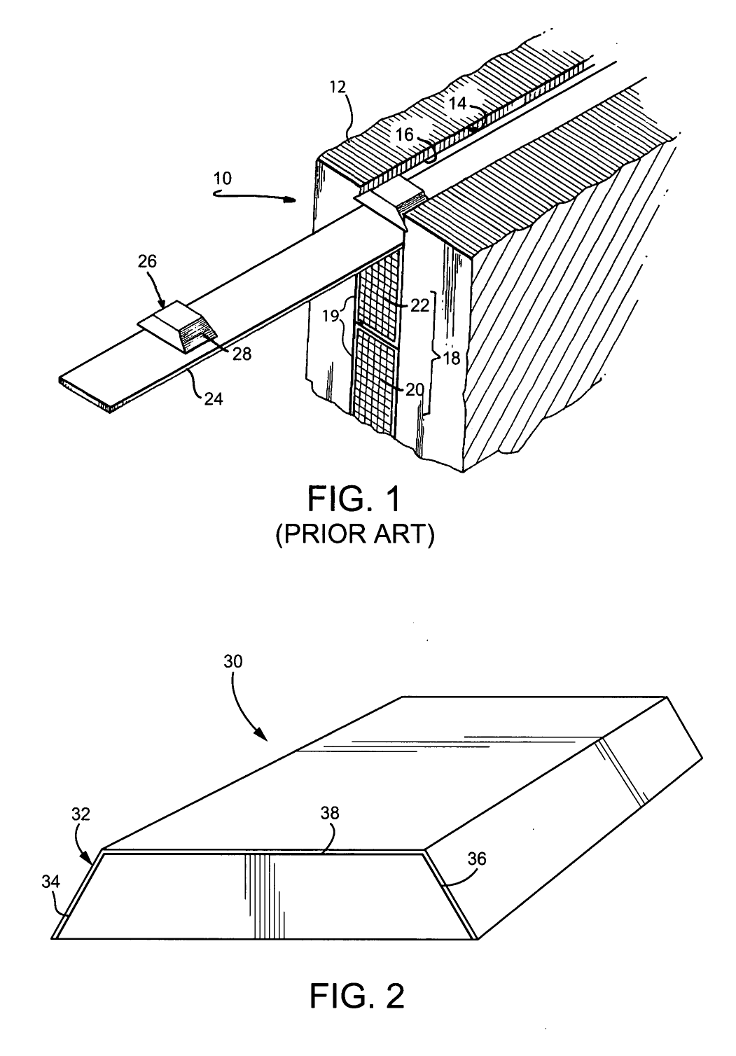

FIG. 1 of the drawings shows a lower portion of a dynamoelectric machine stator core 10. The dynamoelectric machine has a rotor (not shown) and a stator core, the latter being an annular structure which surrounds the rotor when the rotor is assembled within the dynamoelectric machine. The stator core is assembled from a plurality of slotted punchings or laminations 12. The stator core is formed with variable number of radial slots 14 depending on design spaced circumferentially around the inner annulus perimeter (only one shown), and which extend along the axial length of the stator core and which terminate at their radially inner portions in a dovetail slot 16, as well understood in the art. The conductors 18 comprise insulated conductor strands including radially inner and outer bars 20 and 22, respectively. The conductors or conductor bars typically include electrical insulation (not shown) wrapped about the perimeter portions of the conductor package.

In conjunction with the foregoing, a filler strip 24 may extend axially (longitudinally) along the slot radially inward of bar 22. A number of dovetail wedges 26 are introduced into the slot 14 (and spaced apart along the axial length of the slot 14) so as to bear radially against the insulating filler strip 24. The dovetail wedges are formed with oppositely-facing inclined surfaces 28 which engage inclined surfaces of the dovetail slot 16 to facilitate the assembly of the stator bar wedging system. The material of the dovetail wedges 26 is preferably of high-strength insulating material which can be cut or molded to the desired wedge shapes. The wedges are thus preferably formed of a molded resinous compound employing a suitable filler to add strength, or in the alternative, are formed of any suitable commercially-obtainable cotton phenolic materials such as Textolite® (a registered trademark of the General Electric Company). In some designs cotton phenolic wedge by itself lacks the required mechanical strength for thinner wedge configurations.

With reference to FIG. 2, and in accordance with an exemplary, non-limiting implementation of the technology disclosed herein, a wedge 30 constructed of, for example, the fiberglass laminate G11 is covered with at least one layer of woven aromatic polyamide (or aramid) fabric 32. One such fabric is sold under the trade name Kevlar®, but the fabric in this instance is woven, unlike the non-woven Kevlar® felt disclosed in the '818 patent mentioned above. The aramid, woven covering fabric provides a lower coefficient of friction, but even more importantly, provides adequate abrasion and tear resistance, resisting scrapes and tears from the sharp lamination edges at significantly decreased cost. Preferably, the fabric covers at least the inclined side surfaces 34, 36, but as a practical manufacturing matter, the top and/or bottom surface 38 may be covered as well.

The covered wedge as described above may be manufactured by, for example, any of the following methods.

In a first exemplary process, liquefied G11 resin is poured into a mold cavity containing a woven glass roll the length of the wedge 30. The woven aramid fabric 32 is placed over the resin and the assembly is pressed into final shape with heat and pressure.

In a second exemplary process, liquefied G11 resin with woven glass fibers and the woven aramid fabric is pulled (pultrusion) or pushed (extrusion) through a die that produces the desired wedge shape.

In a third process, the G11 resin is shaped by either of the above processes, and the woven aramid fabric is thereafter glued to the wedge.

Other known processes may be equally suitable for forming the woven aramid fabric-covered wedge as described, but it is important that the aramid fabric be bonded to the fiberglass laminate to prevent delamination during use.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A slot wedge for a generator stator comprising a wedge body having top and bottom surfaces and a pair of oppositely inclined side surfaces, wherein at least said oppositely inclined surfaces are covered with a woven aramid fabric.

2. The slot wedge of claim 1 wherein said top surface is also covered with said woven aramid fabric.

3. The slot wedge of claim 1 wherein said wedge body is constructed of a fiberglass laminate.

4. The slot wedge of claim 2 wherein said wedge body is constructed of a fiberglass laminate.

5. The slot wedge of claim 1 wherein said woven aramid fabric is bonded to said wedge body.

6. The slot wedge of claim 1 wherein said woven aramid fabric is glued to said wedge body.

7. The slot wedge of claim 3 wherein said aramid fabric and said fiberglass laminate are bonded.

8. The slot wedge of claim 1 having a width of substantially 1.75 inch or greater.

9. A method of making a slot wedge for a generator stator comprising:
(a) providing a wedge shaped body having top and bottom surfaces connected by oppositely inclined side surfaces; and
(b) covering at least said oppositely inclined side surfaces with a woven aramid fabric.

10. The method of claim 9 wherein step (b) is carried out by pouring a liquefied resin into a mold cavity;
placing the fabric over the resin and pressing the resin and fabric into final shape with heat and pressure.

11. The method of claim 9 wherein step (b) is carried out by pulling or pushing a resin within said fabric on surface(s) through a die.

12. The method of claim 9 wherein step (b) is carried out by gluing the fabric to the wedge body.

13. The method of claim 9 wherein said aramid fabric and said fiberglass laminate are bonded.

14. The method of claim 9 wherein, during step (b), said top surface is also covered with said woven aramid fabric.
